(19) United States
(12) Patent Application Publication
(10) Pub. No.: US 2015/0330145 A1
(43) Pub. Date: Nov. 19, 2015

(54) ROLLER BLIND

(71) Applicant: Marc LEWIS, Victoria (AU)

(72) Inventor: Marc LEWIS, South Yarra (AU)

(21) Appl. No.: 14/650,108

(22) PCT Filed: Dec. 20, 2013
(86) PCT No.: PCT/AU2013/001508

§ 371 Date: Jun. 5, 2015

(30) Foreign Application Priority Data
Dec. 9, 2012 (AU) 2012905342

(51) Int. Cl. E06B 9/60; E06B 9/42

(52) U.S. Cl. CPC E06B 9/60; E06B 9/42

(57) ABSTRACT

A roller mechanism for a blind, comprising a drum around which the blind is to be wound, the drum being configured to engage a lower portion of the blind, wherein the drum is spring loaded and rotatably coupled to a handle for raising and lowering the drum to operate the blind. There is also disclosed an assembly including a roller mechanism of the type described and a blind fitted thereto.

### FIELD OF THE INVENTION

The present invention relates to a roller mechanism for a blind and an assembly of a roller blind. More particularly, but not exclusively, the present invention relates to a roller blind for use with outdoor blinds, such as café blinds, for example.

### BACKGROUND OF THE INVENTION

Retractable roller blinds are commonly used for semi-outdoor or outdoor areas to reduce weather effects incident on the area. Such blinds may be used to block or reduce sunlight, or may be clear to block wind and rain, thereby increasing the usability of a semi-outdoor or outdoor area in different weather conditions. Roller blinds also have indoor applications for controlling the amount of sunlight entering a room through a window.

Generally, previous outdoor roller blinds can be complicated and expensive to manufacture, difficult to install due to their weight, inconvenient to operate and provide poor performance.

Previous roller blinds have been wound around a spring biased drum which is fixed near an upper portion of a window frame or an opening to an outdoor area, with the blind extending downwardly from the drum. To enable the blind to retract, it is necessary to provide a clearance from the window frame or opening, making it difficult to seal the upper edge of the opening. The clearance is increased if the thickness of the blind is increased, thereby making it impractical to greatly increase the thickness of material used or the size of the window opening. It can also be difficult to seal a lower edge of the opening as the lower edge of the blind can be difficult to restrain. Also, as the spring biased drum supports the entire weight of the blind it is necessary for the drum to have adequate strength, thereby increasing the weight of the blind and increasing the difficulty of fixing the blind to the window frame. Furthermore, due to the action of the blind, it is difficult to join adjacent blinds to each other to close off a large area as each blind needs to move independently of an adjacent blind.

Rope and pulley blinds have also been proposed and operate via a rope or other cable that extends downwardly from an upper portion of the blind to a lower edge of the blind so as to draw the lower edge of the blind upwardly when the rope is pulled. Ropes extending across the blinds can be unsightly, detracting from the aesthetics of the blind, and can cause damage to the blind as the rope can come into contact with the blind during retraction. Any dangling ropes involved with a blind can also be a hazard to minors

Examples of the invention seek to solve, or at least ameliorate one or more disadvantages of previous roller blinds, or to provide a useful alternative.

### SUMMARY OF THE INVENTION

According to the present invention, there is provided a roller mechanism for a blind, comprising a drum around which the blind is to be wound, the drum being configured to engage a lower portion of the blind, wherein the drum is spring loaded and rotatably coupled to a handle for raising and lowering the drum to operate the blind.

According to a preferred embodiment, the handle includes a bar extending generally across the blind and parallel to the drum for engagement by a user to operate the blind.

Preferably, the bar has a bracket fixed at either end thereof, the drum being rotatably mounted in each bracket. In one form, at least one of the brackets has a stopper extending therefrom to engage a side of the blind to prevent the bracket from rotating with the drum. In another form, the bracket is configured so that the bar engages a side of the blind.

According to preferred embodiments, the roller mechanism is configured to engage the blind at a location offset from a bottom edge of the blind. Preferably, the drum has a first longitudinally extending recess formed in an outer surface thereof, the recess being configured to receive the blind to fix the blind to the drum. The roller mechanism can further include at least one grounding strap extending from the drum for securing a lower portion of the blind. The drum can have a second longitudinally extending recess formed in an outer surface thereof, the grounding strap(s) being received in the second recess.

According to preferred embodiments, the drum is generally cylindrical.

According to the present invention, there is also provided a roller mechanism of the above described type and a blind fitted thereto.

Preferably, the blind is an outdoor blind. Preferably, the blind has a zipper extending along at least one side thereof for connection of the blind to adjacent blind(s).

### BRIEF DESCRIPTION OF THE DRAWINGS

Preferred embodiments of the invention will be further described, by way of non-limiting example only, with reference to the accompanying drawings in which:

FIG. 1 is a side elevation of a roller blind having a roller mechanism of one embodiment of the invention;

FIG. 2 is a close side elevation of the roller blind showing components of the blind in greater detail;

FIG. 3 is a perspective view of a blind assembly according to a preferred embodiment of the invention;

FIG. 4 is another perspective view of the blind assembly; and

FIG. 5 is a elevation of a blind assembly in different conditions of use.

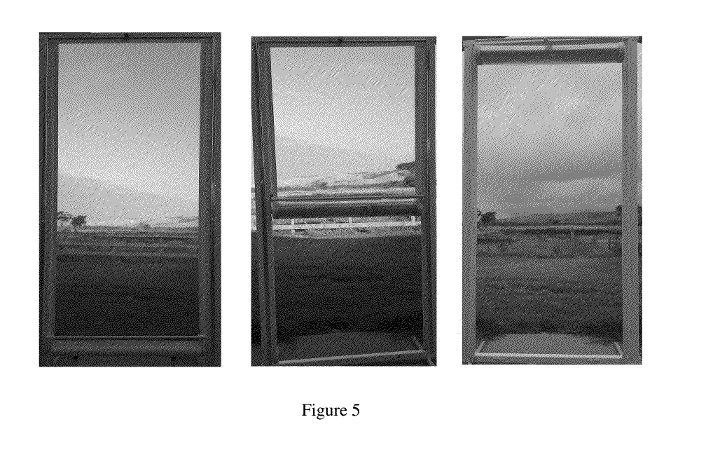

### DETAILED DESCRIPTION

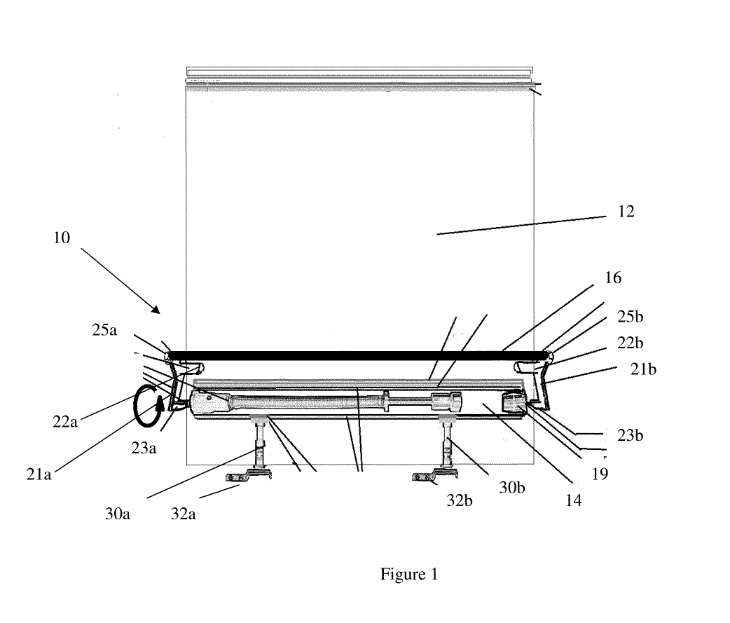

A roller mechanism 10 according to a preferred embodiment of the present invention is shown in FIG. 1. The roller mechanism 10 is configured for use with a blind 12 such as an outdoor blind made of 1 mm sheet PVC material.

The roller mechanism 10 comprises a drum 14 around which the blind 12 is to be wound. The drum 14 is generally cylindrical and configured to engage the blind at a location offset from a lower edge of the blind 12. Preferably, the drum 14 engages the blind at a distance of approximately 190 mm from a lower edge of the blind 12. The drum 14 is spring loaded and rotatably coupled to a handle 16 for raising and lowering the drum 14 to operate the blind 12. Operation of the blind 12 includes winding or unwinding the blind 12 around the drum 12 to extend or retract the blind 12.

The drum 14 has an internal spring mechanism 18 disposed within the drum 14 which allows the roller mechanism 10 to be automatically retracted when required. The internal spring mechanism 18 includes a spiral wound biasing element that provides the rotating force and a clutch mechanism to allow selective use of the spring mechanism 18. The spring mechanism 18 includes a central shaft for fixing to the roller mechanism 10 and which is to be generally stationary in use. The spiral wound biasing element extends around this central shaft and engages the drum 14 so as to rotate the drum in use. The spring mechanism 18 has an end plug 19 at one end which is freely rotatable in the roller mechanism 10 to rotate the drum 14.

In the described embodiment, the handle 16 is in the form of a bar extending generally across the blind 12 and parallel to the drum 14 for engagement by a user to operate the roller mechanism 10. The bar 16 is offset from the blind 12 so as to not interfere with movement of the blind 12 as it is wound/unwound on the drum. Although the bar 16 is shown as a single piece extending across the blind 12, it will be appreciated that it may formed in multiple pieces that do not necessarily extend entirely across the blind 12. In use, the mechanism 10 is operated by a user by grasping the bar 16 and pulling it downward to unwind the blind 12 from the drum 16 or by lifting the bar 16 so as to retract the blind 12 so that it is wound around the drum 16. In use, the bar 16 can move from a position above the drum 14 during raising or a position below the drum 14 during lowering. Movement of the bar 16 allows the blind 12 to extend or retract. During use, the spring loaded action of the blind 12 provides that only a small amount of effort is required by a user to raise or lower the blind.

A pair of hooks may be provided near an upper edge of the window to secure the blind 12 when in a raised position.

The bar 16 has a bracket 20a, 20b fixed at either end thereof. The roller mechanism 10 is configured so that the drum 14 is rotatably mounted in each bracket 20a, 20b. In this regard, each bracket 20a, 20b has an extension 21a, 21b on which a boss 23a, 23b is disposed for receiving the drum 14. Furthermore, each bracket 20a, 20b has a mounting 25a, 25b which is configured for engagement with ends of the bar 16. In use, as the blind 12 is wound around or unwound from the drum 14, the brackets 20a, 20b are configured to generally resist rotation so that they only move in a vertical plane.

In the illustrated embodiment, each bracket 20a, 20b has a stopper 22a, 22b extending therefrom to engage a side face of the blind 12 to prevent the brackets 20a, 20b from rotating with the drum 14. Although the illustrated brackets 20a, 20b are shown as each having a stopper 22a, 22b it will be appreciated that only a single bracket 20a or 20b may be provided with a stopper.

In an alternative embodiment, brackets 20a, 20b are not provided with stoppers so that the bar 16 is free to contact the blind 12 in use.

Each bracket 20a, 20b is configured to be close fitting to an edge of the blind 12 whilst providing enough clearance for a zipper extending along the edge of the blind 12 to allow for connection of the blind 12 to adjacent blind(s) so that a large outdoor area may be closed off using multiple blinds.

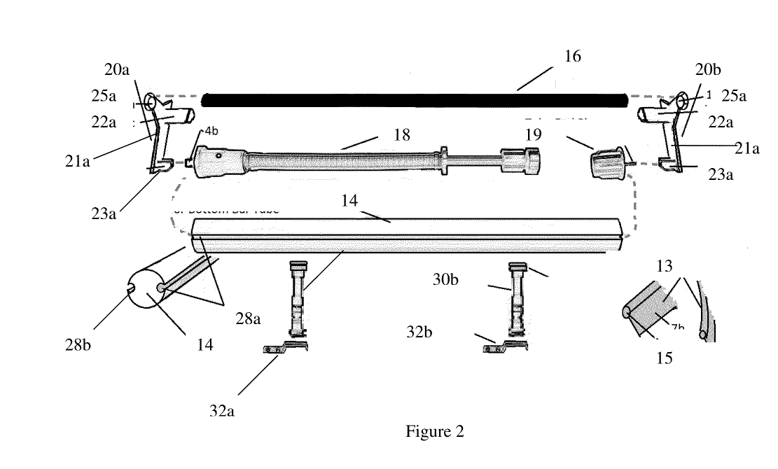

As illustrated in FIG. 1 and discussed above, the roller mechanism 10 is fixed to a portion of the blind 12 which is offset from a lower edge of the blind 12. In this regard, the blind 12 has a strip of material 13 (see FIG. 2) fixed thereto and extending transversely across the blind 12. The strip of material 13 may be fixed to the blind 12 by using a sewing process of by using an adhesive. The strip of material 13 is formed with a cylindrical portion 15 extending across one end thereof and which is configured for fixing to the blind 12, as will be discussed further below. As the strip of material 13 can be easily fixed to a blind it allows the roller mechanism 10 to be fitted to existing blinds. Also, fixing the strip of material 13 to the blind 12 allows edges of the blind 12 to be unobstructed so that the blind 12 can be provided with zippers extending along sides thereof so that the entire side of the blind can be fixed to an adjacent blind.

It will also be appreciated that the roller mechanism 10 may be fixed to a lower edge of the blind 12 and a separate weather flap 26 provided which is in the form of a sheet of material extending downwardly from the drum 14.

As illustrated in FIG. 2, the drum 14 has two longitudinally extending recesses 28a, 28b formed in an outer surface thereof. In the illustrated embodiment, each recess 28a, 28b is in the form of a keyway, one of which is configured to receive the cylindrical portion 15 fixed to the blind 12. The cylindrical portion 15 is complimentary shaped with one of the recesses to allow the blind 12 to be fixed to the drum 14. In the illustrated embodiment, the recesses 28a, 28b are circular and configured so that either of them can receive the corresponding cylindrical portion 15 formed in the strip of material 13 so that the blind 12 is keyed to the drum 14. It will be appreciated that the recesses may take other shapes and that the corresponding portions of the blind 12 will be formed in shapes corresponding to the recesses so as to be keyed to the drum. In the illustrated embodiment the circular recesses 28a, 28b allow the drum 14 to be easily formed using conventional processes, such as extrusion processes. In the described embodiment, the drum 14 is preferably formed of extruded aluminium so as to be light weight.

The roller mechanism 10 also includes a pair of grounding straps 30a, 30b to secure the drum 14 and a lower portion of the blind 12. In this regard, the drum 14/lower portion of the blind 12 may be fixed to a ground surface or a lower portion of a window frame to prevent it from flapping. However, a lowermost edge of the blind 12 will be free to move. The blind 12 is preferably longer than the opening so that a small portion of the blind 12 will lie over the ground.

Although the roller mechanism is shown as being secured with a pair of grounding straps, it will be appreciated that it may be restrained with only a single strap or more than one strap, depending on the particular application in which it is used and having regard to the size of the blind to be secured. In this regard, it will be appreciated that larger blinds may require additional straps to secure it against movement.

Each grounding strap 30a, 30b is formed with a cylindrical portion which is configured to be received in one of the recesses 28a, 28b. Each strap 30a, 30b is received by a respective fastener 32a, 32b which fixed to a ground surface to secure the blind to the ground surface. Advantageously, a lower portion of the blind 12 can be secured against movement by securing the drum 14. By securing the drum 14 which is a rigid part, the entire blind 12 may be held taut. By providing the grounding straps 30a, 30b with a cylindrical portion, they can be moved along the drum 14 to suit a specific application or easily removed.

The grounding straps 30a, 30b may be provided with a tensioner that increases the blind tension. In the illustrated embodiment, the straps 30a, 30b are generally flat so as to be rolled up with the blind 12 when retracted. A hook configured to engage each strap may be provided near a lower portion of the window to allow the straps to be secured to the ground.

Although the illustrated grounding straps 30a, 30b are shown as being fixed to the drum 14 via the recesses 28a, 28b, it will be appreciated that they may be otherwise fixed to the drum 14 or to the blind 12.

The roller mechanism 10 and blind 12 together form an assembly that may be fitted to a window frame or opening of an outdoor area such as a veranda. In this regard, the blind may be fitter to an upper portion of the window frame using commercially available fixing means. However, it will be appreciated that the roller mechanism 10 may be supplied as a retrofit unit for fitting to existing blinds, such as 1 mm PVC blinds for example. In this regard, the strip of material 13 may be fitted to an existing blind to allow fixing to the drum so that the roller mechanism 10 may used. In alternative embodiments, the blind may otherwise be sandwiched between a cylindrical fastener, which is slid or pressed into the recesses 28a, 28b, and the drum 14 when the cylindrical fastener is inserted into either recess. Although the roller mechanism 10 has been described as being for use with outdoor blinds, it will also be appreciated that it may similarly be used for internal blinds.

An assembly of the roller mechanism 10 and blind 12 provides a blind system that may be simple to manufacture and easy to use. As the blind 12 is fixed to the drum 14, there is no load placed on the spring mechanism when the blind is tensioned, thereby reducing wear on the rotating components of the assembly, thereby reducing strength requirements so that the assembly can be formed of a lighter weight. Furthermore, as the roller mechanism 10 engages a lower portion of the blind 12, the blind can easily be used to partially close or cover an opening and the handle is conveniently placed for engagement by a user. Also, providing a handle that can conveniently be engaged by a user eliminates the need for cords or ropes and pulleys to operate the blind; such cords can be unsightly, cause damage to the blind by scratching, marking or creasing the blind, detract from the aesthetics of the blind and present a hanging danger to children or a tripping hazard. A plurality of assemblies interconnected via zippers may be provided to effectively close off a large area from the external environment and provide better thermal isolation than previously achievable. Because the roller mechanism 10 can be retrofitted to existing blinds, these advantages can be achieved without completely replacing an existing blind.

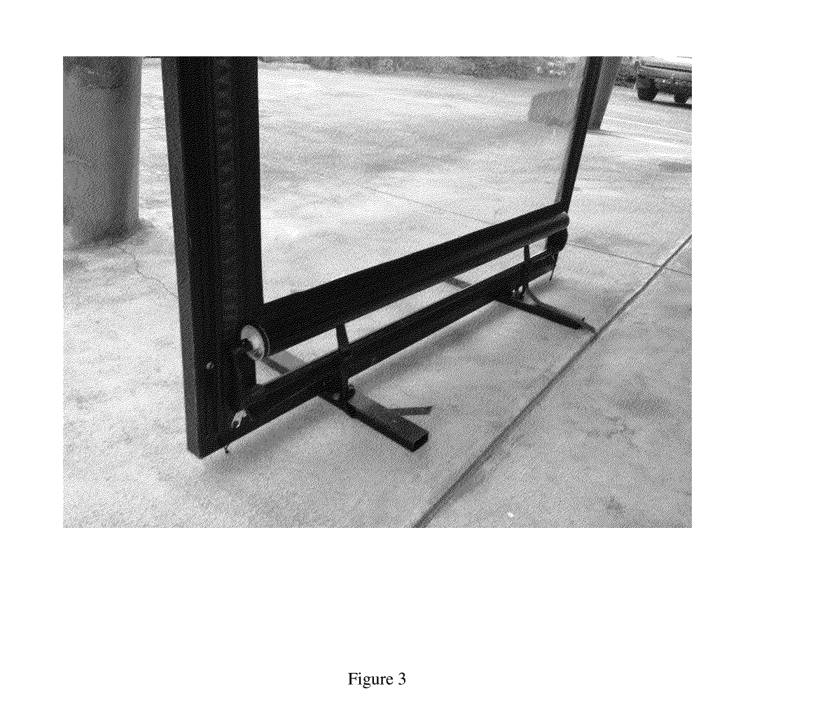

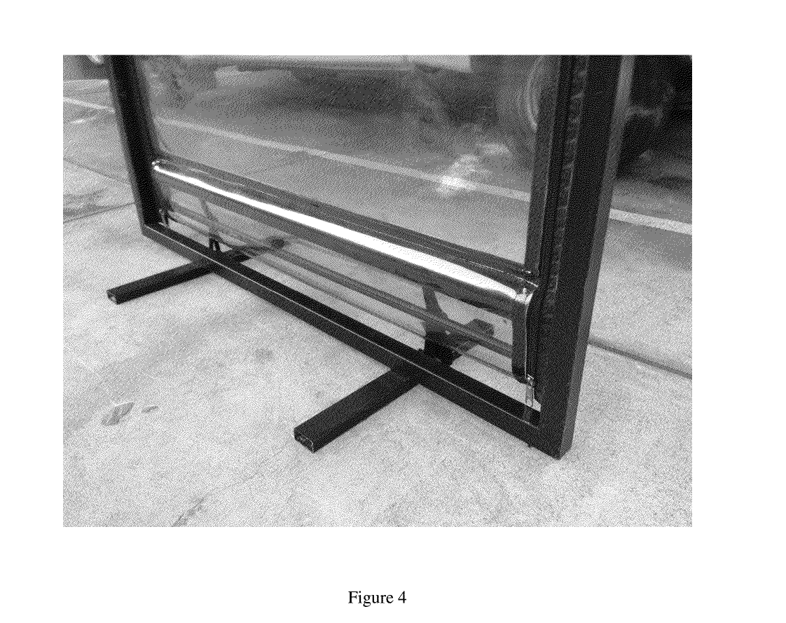

FIGS. 3 and 4 illustrate an assembled and installed blind assembly including a blind 12 and a roller mechanism 10 of the above described type. Zippers 17 are disposed along sides of the blind to secure the blind to the frame 40. In other embodiments, the zippers 17 may be configured to engage zippers of adjacent blinds. As can be seen in FIG. 4, the mechanism engages the blind at an intermediate location so that the blind has a lower portion that sits below the drum when the blind is in a closed position. The blind 12 may be formed of a single piece of in multiple pieces.

The embodiments have been described by way of example only and modifications are possible within the scope of the invention disclosed. For example, although the described blinds have been described with reference to outdoor applications, it will be appreciated that embodiments will similarly be suitable for indoor use.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A roller mechanism for a blind, comprising a drum around which the blind is to be wound, the drum being configured to engage a lower portion of the blind, wherein the drum is spring loaded and rotatably coupled to a handle for raising and lowering the drum to operate the blind.

2. The roller mechanism as claimed in claim 1, wherein the handle includes a bar extending generally across the blind and parallel to the drum for engagement by a user to operate the blind.

3. The roller mechanism as claimed in claim 1, wherein the bar has a bracket fixed at either end thereof, the drum being rotatably mounted in each bracket.

4. The roller mechanism as claimed in claim 3, wherein at least one of the brackets has a stopper extending therefrom to engage a side of the blind to prevent the bracket from rotating with the drum.

5. The roller mechanism as claimed in claim 1, wherein the roller mechanism is configured to engage the blind at a location offset from a bottom edge of the blind.

6. The roller mechanism as claimed in claim 1, wherein the drum has a first longitudinally extending recess formed in an outer surface thereof, the recess being configured to receive the blind to fix the blind to the drum.

7. The roller mechanism as claimed in claim 6, further including at least one grounding strap extending from the drum for securing a lower portion of the blind.

8. The roller mechanism as claimed in claim 7, wherein the drum has a second longitudinally extending recess formed in an outer surface thereof, the grounding strap(s) being received in the second recess.

9. The roller mechanism as claimed in claim 1, wherein the drum is generally cylindrical.

10. An assembly including a roller mechanism according to claim 1 and a blind fitted thereto.

11. The assembly of claim 10, wherein the blind is an outdoor blind.

12. The assembly of claim 11, wherein the blind has a zipper extending along at least one side thereof for connection of the blind to adjacent blind(s).

13. The assembly of claim 10, including a plurality of roller mechanisms each having a blind fitted thereto.
